(19) United States
(12) Patent Application Publication
(10) Pub. No.: US 2016/0114840 A1
(43) Pub. Date: Apr. 28, 2016

(54) High Performance Track System For a Vehicle

(71) Applicant: Soucy International Inc., Drummondville (CA)

(72) Inventors: Patrick L'HERAULT, St-Majorique de Grantham (CA); Louis-Frederic MARCHILDON, Drummondville (CA)

(21) Appl. No.: 14/920,783

(22) Filed: Oct. 22, 2015

Related U.S. Application Data
(60) Provisional application No. 62/067,153, filed on Oct. 22, 2014.

(51) Int. Cl. B62D 55/084; B62D 55/065; B62D 55/06; B62D 55/24

(52) U.S. Cl. CPC B62D 55/084; B62D 55/244; B62D 55/065; B62D 55/06

(57) ABSTRACT

A track system for use as a wheel replacement on a typically wheeled vehicle is disclosed. The track system comprises a drive wheel configured to be mounted to the vehicle, a support frame, front and rear idler wheels respectively mounted at the front and at the rear of the support frame, road wheels pivotally mounted along the support frame between the front and read idler wheels, and an endless track mounted about the wheels. The track system has a large diameter sprocket in combination with a very low track band tension resulting in increased performances and improved handling of the vehicle.

### CROSS-REFERENCE TO RELATED APPLICATIONS

The present patent application claims the benefits of priority of U.S. Provisional Patent Application No. 62/067,153, entitled “High Performance Track System For a Vehicle”, and filed at the United States Trademark and Patent Office on Oct. 22, 2014, the content of which is incorporated herein by reference.

### FIELD OF THE INVENTION

The present invention generally relates to track systems and traction assemblies for use as wheel replacement on typically wheeled vehicles, and more particularly relates to track systems and traction assemblies for use as wheel replacement on typically small vehicles such as, but not limited to, all-terrain vehicles (ATVs), utility-terrain vehicles (UTVs), and side-by-side vehicles (SSVs). The present invention also relates to track systems and traction assemblies for use as wheel replacement on large wheeled vehicles such as, but not limited to, industrial vehicles, construction vehicles, agricultural vehicles, and forestry vehicles.

### BACKGROUND OF THE INVENTION

Nowadays, there are an ever-increasing number of people who enjoy riding all-terrain vehicles and other similar off-road vehicles. There are generally two mainly use for these vehicles; working and riding. In order to further adapt these vehicles to the increasing variety of terrains and surfaces onto which they are ridden, companies have started to offer traction assemblies which can be used to replace the wheels on these vehicles. These track assemblies are mainly designed for working applications.

Generally, a traction assembly comprises a supporting frame, a sprocket wheel, idler and/or road wheels and an endless elastomeric track disposed there around and cooperating therewith. By using an endless track instead of regular tire, a traction assembly generally provides increased floatation and better traction to the vehicle since the ground contacting area, also referred to as the contact patch, of the endless track is generally significantly larger than the contact patch of a regular tire. Also, a smaller sprocket wheel diameter in the order of 60% of the wheel diameter is generally required to compensate increased rolling resistance of the traction assembly.

In short, the larger ground contacting area of the endless track effectively spreads the weight of the vehicle over a larger area (i.e. increased floatation) and provides additional ground-engaging surface to the vehicle (i.e. increased traction), but results in a speed loss and higher gas consumption.

Though the larger contact patch of the endless track of the traction assembly is generally a significant advantage when the vehicle is ridden over soft surfaces such as snow, mud or sand, the larger contact patch can become a hindrance when the vehicle is ridden over harder surfaces such as concrete, asphalt, snow groomed trail or pavement.

Indeed, the larger contact patch generally implies more friction between the track and the ground, making the vehicle more difficult to steer and maneuver. Also, the smaller sprocket size diameter, which is generally an advantage over soft terrain, becomes a hindrance when ridden over harder surfaces (such as a groomed snow trail) because of the top speed loss. This is why tires are generally used over these hard surfaces and terrains, see FIGS. 1 and 2 showing prior art example.

Particularly on a snow groomed trails, tires are still not the best option. There are many disadvantages such as lack of traction, difficulty to get out of the ruts, high speed instability, cornering instability, etc.

Hence, there is a need for an improved traction assembly which generally mitigates the aforementioned shortcomings.

### SUMMARY OF THE INVENTION

The shortcomings of the prior art are generally mitigated by providing a track system having large diameter sprocket in combination with a low track tension. As such, the large diameter sprocket and low track tension allows the track system to achieve better performance than known track systems especially on harder surfaces.

According to an aspect of the present invention the track system comprises a larger diameter sprocket such that a ratio of the sprocket diameter relative to the tire diameter is preferably between 65 to 100%.

According to an aspect of the present invention the track system uses a lower track tension, improving the track performance while reducing rolling resistance between the track band and the ground.

According to an aspect of the present invention the track system may comprise a narrower track band also improving driving conditions by reducing the rolling resistance on harder surfaces.

According to an aspect of the present invention the track system provides the vehicle with higher performance compared with known track systems because of the synergistic combination of the larger diameter sprocket or driving wheel size and lower track tension.

According to yet another aspect of the present invention the track band comprises a double guide teeth to better support the idler and road wheels, thus diminishing the occurrence of derailing of the track band from the track system.

The invention is directed to a high performance track system for replacing a tire-wheel assembly of a vehicle, the track system comprising a supporting frame, a sprocket wheel pivotally mounted to the supporting frame and operationally connected to a driving shaft of the vehicle, and a plurality of idler wheels pivotally mounted to the supporting frame for guiding an endless track disposed around the plurality of idler wheels and the sprocket wheel. The sprocket wheel has a diameter between 65% and 100% of the diameter of the replaced tire-wheel assembly of the vehicle, and the endless track has a tension limiting derailment of the endless track.

The invention is further directed to a vehicle equipped with a pair of track systems as defined herein above.

The invention is yet further directed to a vehicle equipped with a plurality of pairs of track systems as defined herein above.

The invention is also directed to a high performance track system for replacing a tire-wheel assembly of a vehicle, the track system comprising a supporting frame comprising a guiding slide for guiding a lower run of an endless track and for limiting a derailment of the endless track, a sprocket wheel comprising teeth pivotally mounted to the supporting frame and operationally connected to a driving shaft of the wheeled vehicle, a plurality of idler wheels pivotally mounted to the supporting frame for guiding the endless track disposed around the plurality of idler wheels and the sprocket wheel. The endless track comprises an inner wheel-engaging surface, an outer ground-engaging surface, widthwise reinforcing rods, and apertures to be engaged by the teeth of the sprocket wheel. The inner wheel-engaging surface comprises inner guide lugs and outer guide lugs, and the sprocket wheel has a diameter between 65% and 100% of the diameter of the tire-wheel assembly of the vehicle, and the endless track has a tension limiting derailment of the endless track.

The invention is also further directed to a vehicle equipped with a pair of track system as defined herein above.

The invention is also yet further directed to a vehicle equipped with a plurality of pairs of track systems as defined herein above.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a front elevation view of a prior art ATV.

FIG. 2 is a right elevation view of the ATV of FIG. 1.

FIG. 3 is a front elevation view of an ATV having a track system according to an embodiment of the present invention.

FIG. 4 is a right elevation view of the ATV of FIG. 3.

FIG. 5 is a perspective view of an embodiment of a high performance track system in accordance with the principles of the present invention.

FIG. 6 is an exploded view of the track system of FIG. 5

FIG. 7 is an outer elevation view of the track system of FIG. 5.

FIG. 8 is an exploded view of the track system of FIG. 7.

FIG. 9 is an inner elevation view of the track system of FIG. 5.

FIG. 10 is an exploded view of the track system of FIG. 9.

FIG. 11 is a cross sectional view along the line A-A of FIG. 5.

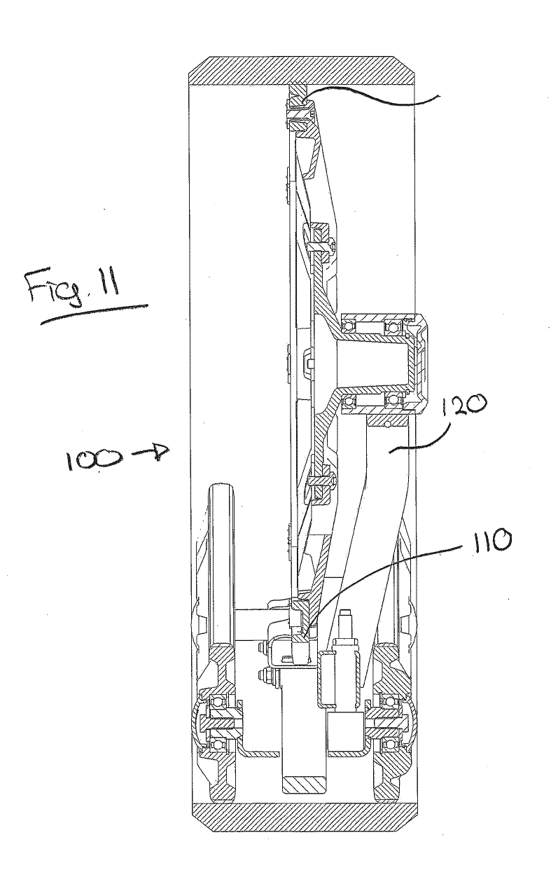

FIG. 12 is a bottom plan view of the internal components of the track system of FIG. 5.

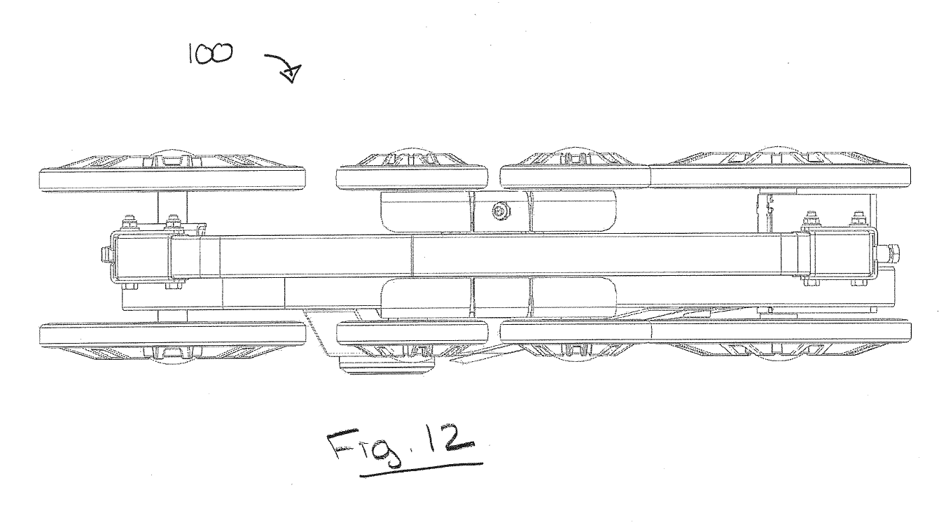

FIG. 13 is a top plan view of the internal components of the track system of FIG. 5.

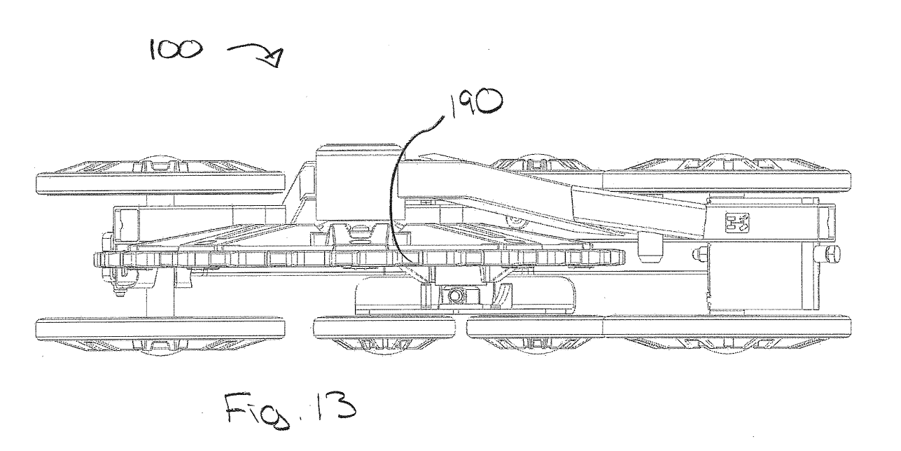

FIG. 14 is an expanded view of a portion of a track band and sprocket of the track system according to the present invention.

FIG. 15 is an upper perspective view the track system of FIG. 14.

FIG. 16 is an inside view of a portion of the track band of the track system of FIG. 14.

FIG. 17 is a perspective view a cross section along axis B-B of the track band of FIG. 16.

FIG. 18 is a perspective view the portion of the track band of FIG. 16.

FIG. 19 is front elevated view of tension tester tool.

FIG. 20 is side elevation view of the track system of FIG. 5 during tension measurement.

FIG. 21 is a graphic representation of an example measurement of the efficiency of various track system configuration compared with the original vehicle wheel.

FIG. 22, is a graphic representation of an example measurement of the efficiency of various track system configuration compared with the original vehicle wheel.

### DETAILED DESCRIPTION OF THE PREFERRED EMBODIMENT

A novel high performance track system will be described hereinafter. Although the invention is described in terms of specific illustrative embodiments, it is to be understood that the embodiments described herein are by way of example only and that the scope of the invention is not intended to be limited thereby.

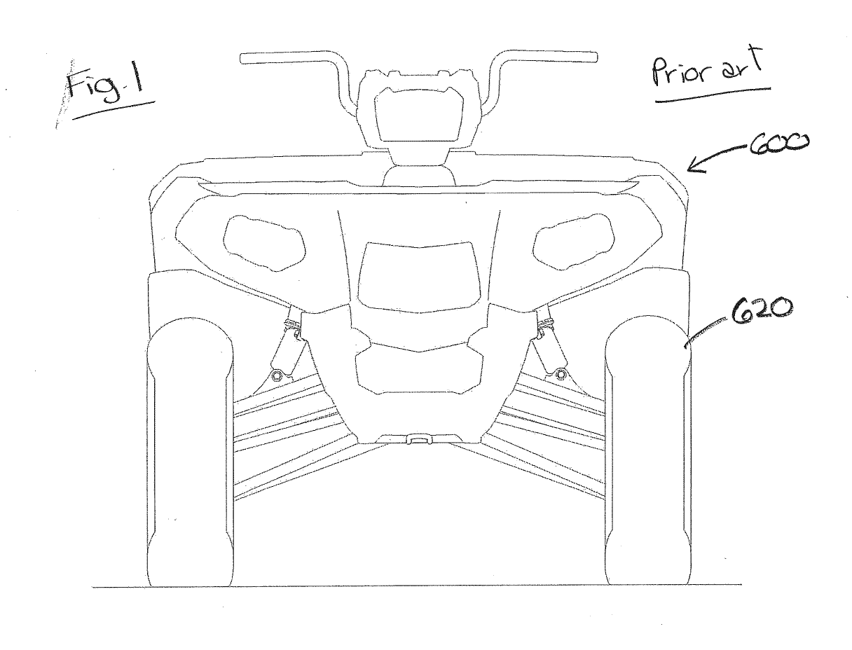

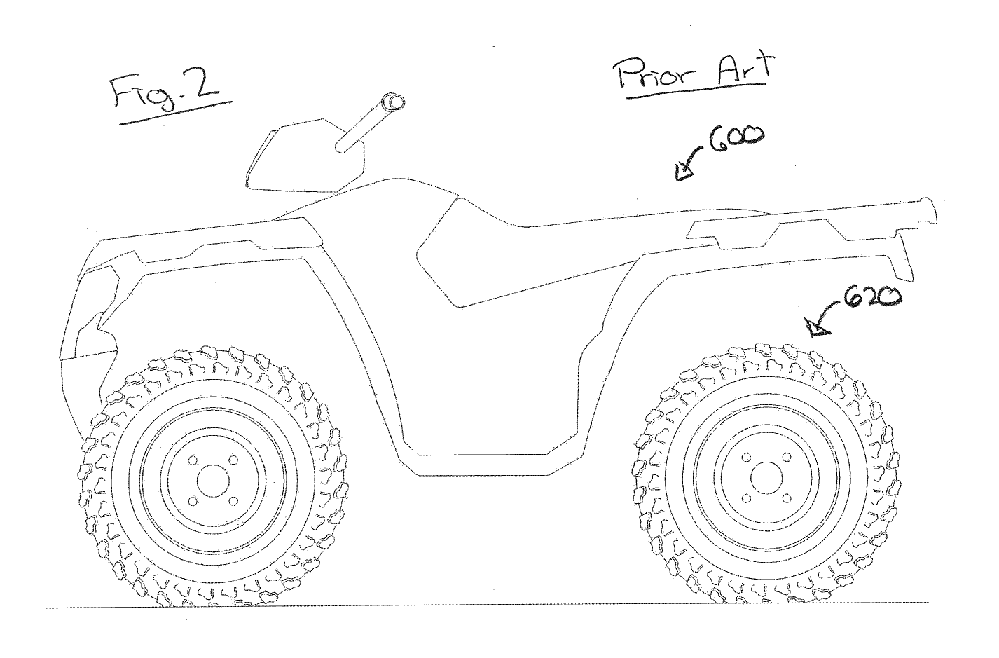

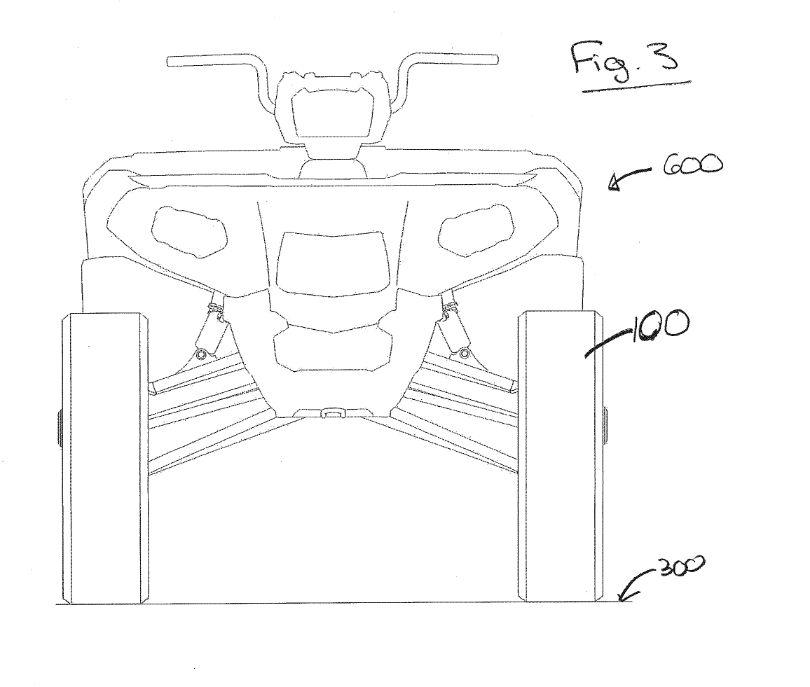

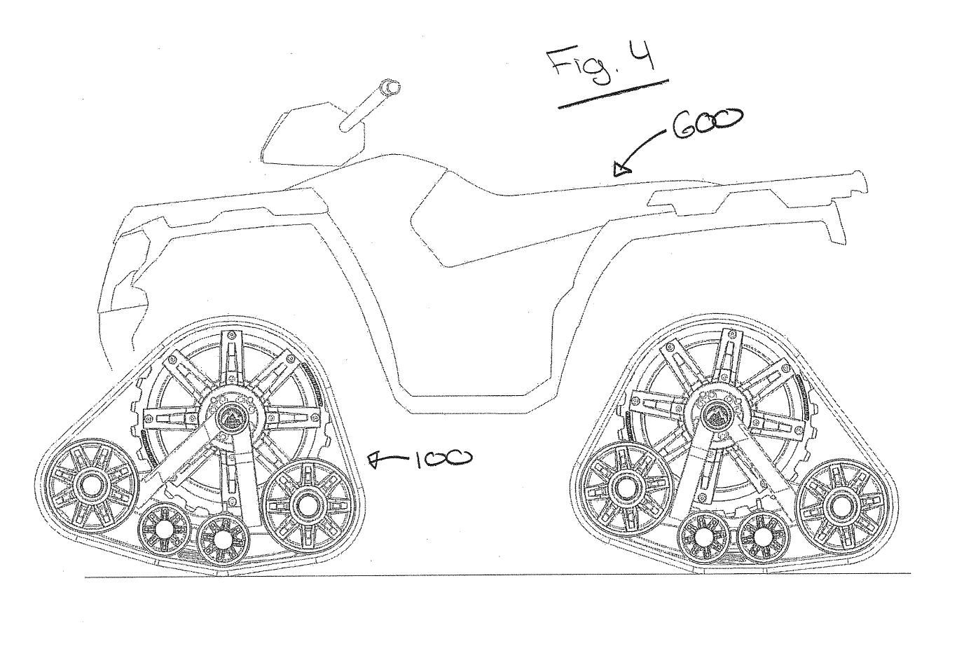

Referring first to FIGS. 1-4, an embodiment of a track system 100 in accordance with the principles of the present invention is shown. The track system 100 is configured to replace a wheel on a typically wheeled vehicle 600 to generally improve the floatation and/or traction thereof. In the present embodiment, the track system 100 is configured to replace front and rear wheels 620 on a typically small wheeled vehicle such as an ATV, a UTV, a SSV or any other similar recreational vehicle (see ATV 600 in FIGS. 1-2).

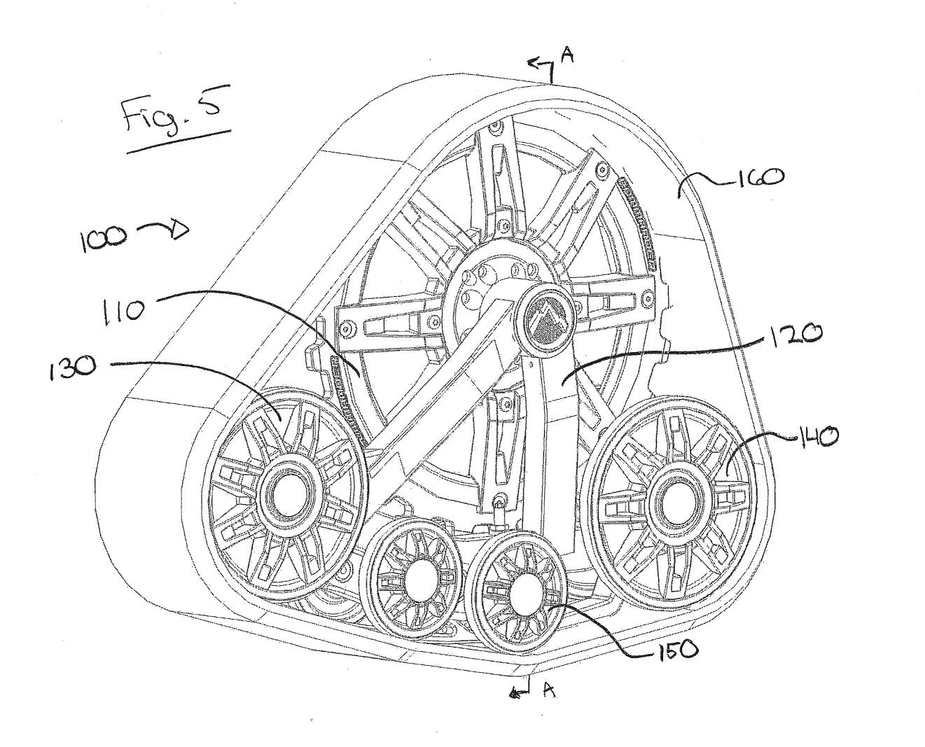

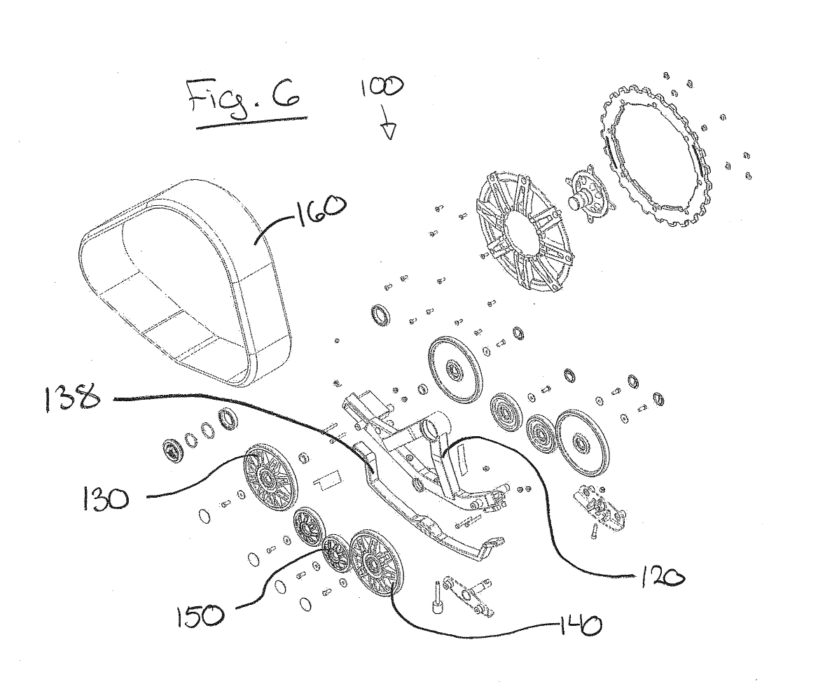

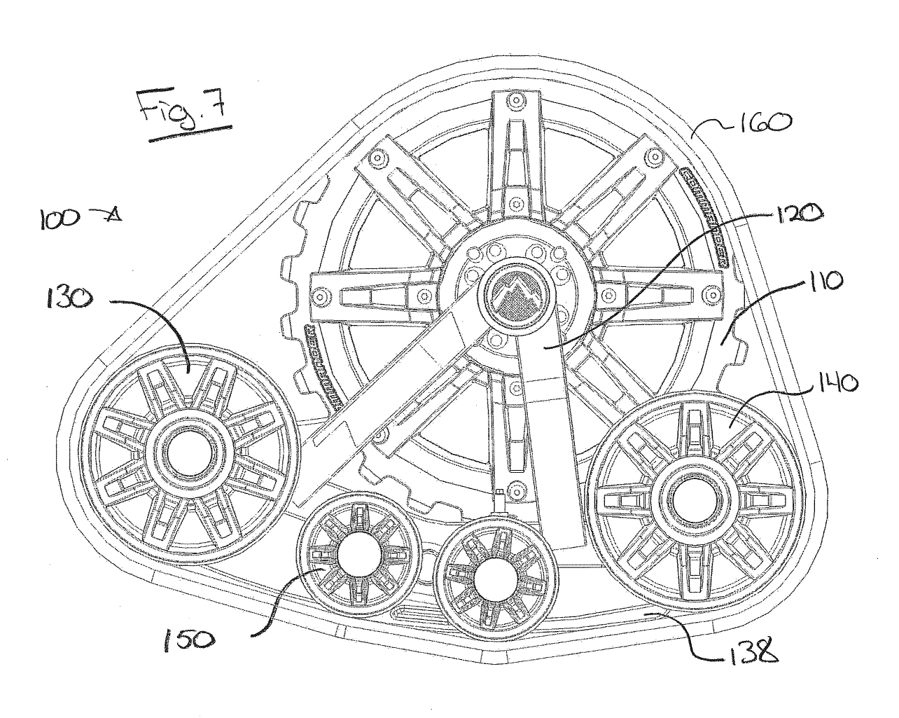

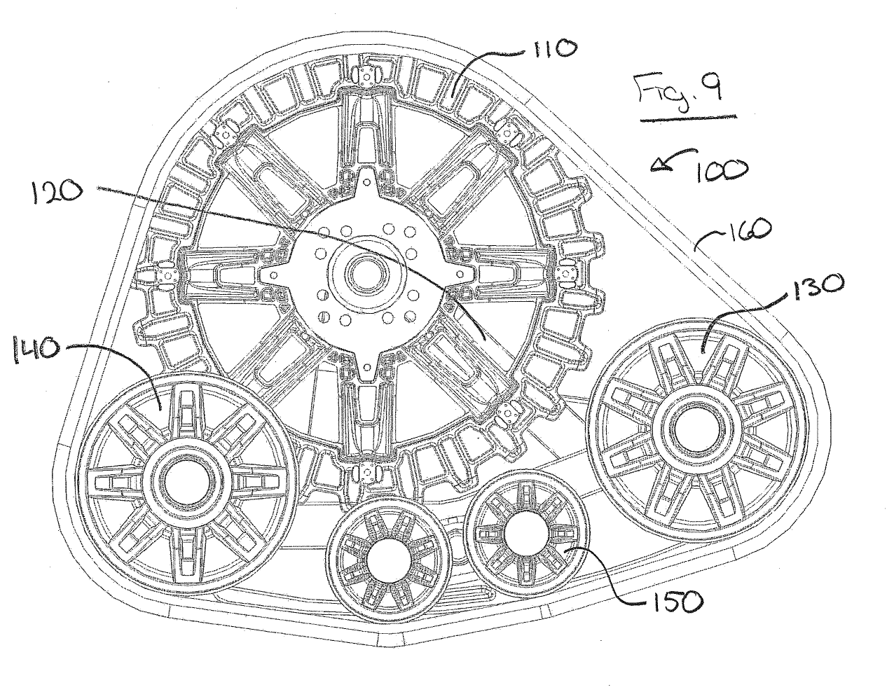

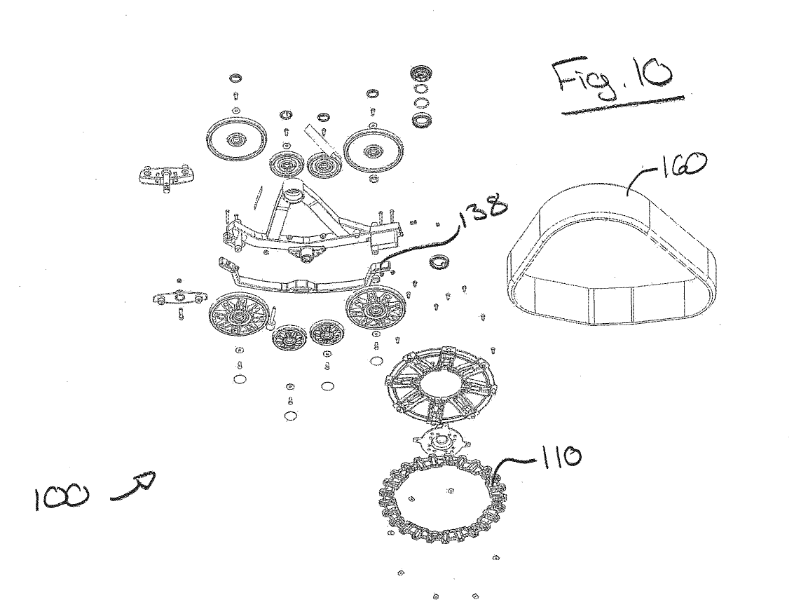

Now referring to FIGS. 5-10, the track system 100 comprises a drive wheel 110 (sometimes referred to as a sprocket wheel) configured to be mounted to the vehicle, typically to a wheel hub thereof, a support frame 120, front idler wheels 130 and rear idler wheels 140 respectively pivotally mounted to the support frame 120 at the forward end 122 and at the rearward end 124 thereof, road (or support) wheels 150 pivotally mounted to the support frame 120 along its length, typically on both sides, and an endless track 160 disposed about the drive wheel 110, the idler wheels 130 and 140 and the road wheels 150, and configured to be drivingly engaged by the drive wheel 110.

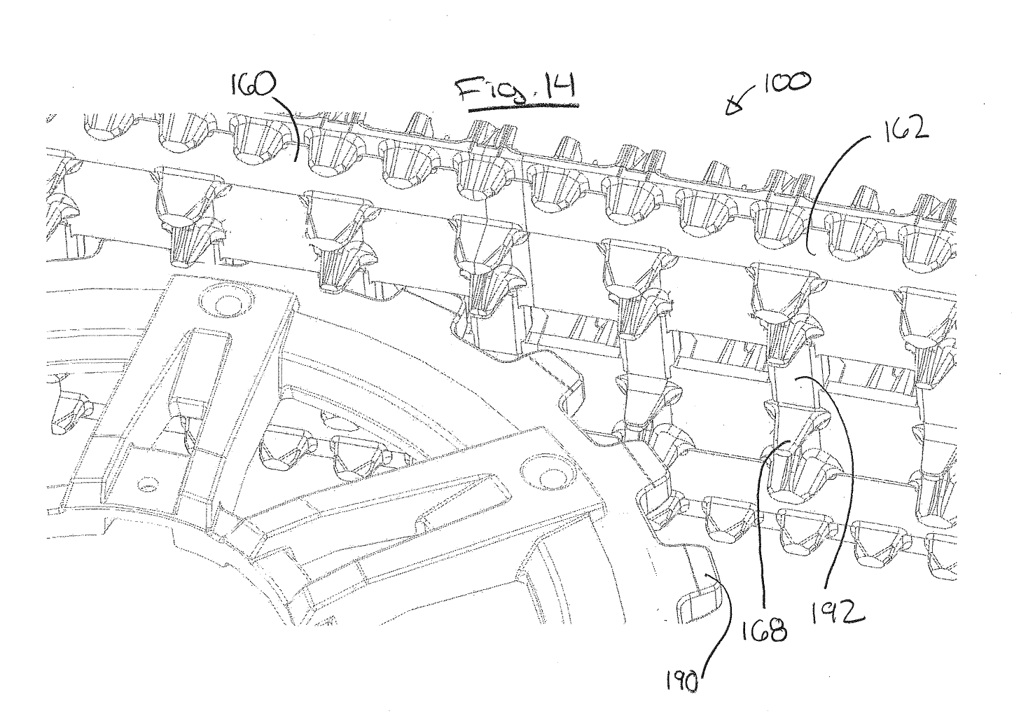

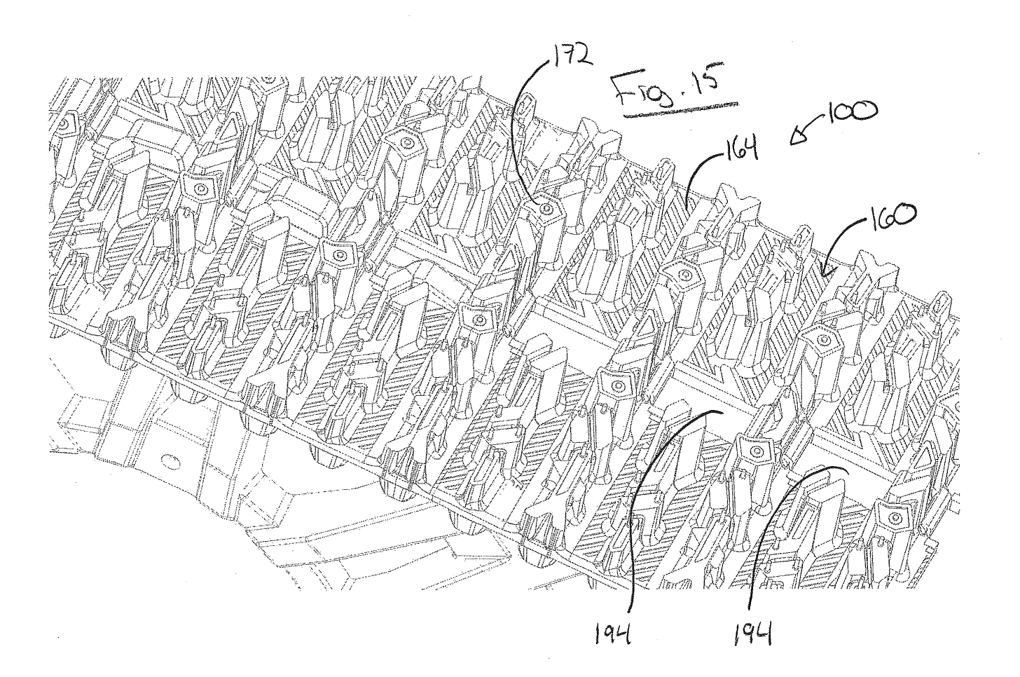

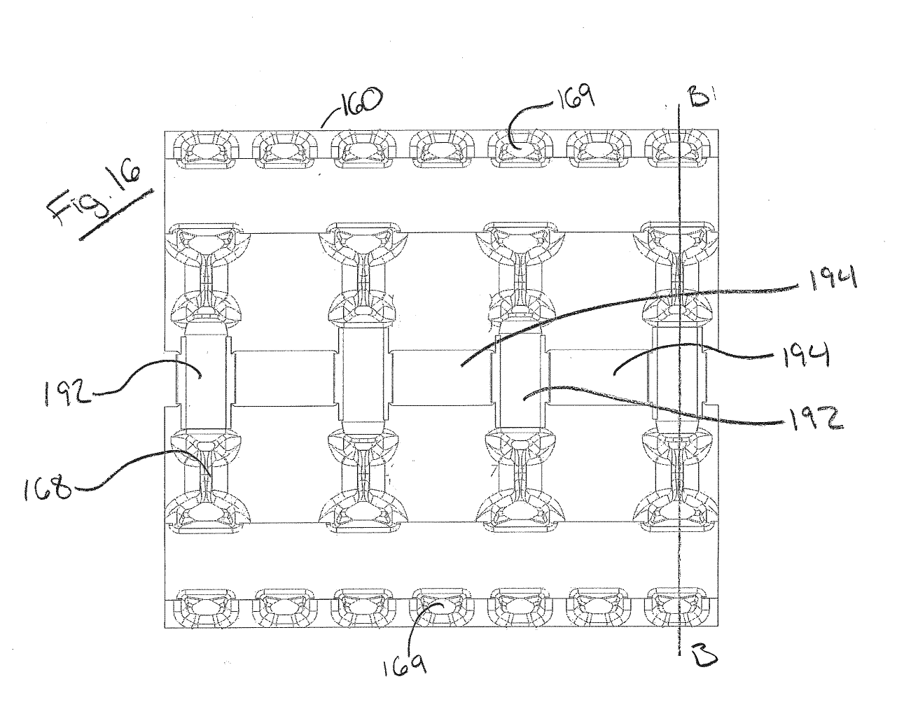

Still referring to FIGS. 5-10, in the present embodiment, the drive wheel 110 is a sprocket wheel and drivingly engages the track 160 via holes 194 (see FIG. 15) located between sprocket contacting sections (clips) 192 (see FIG. 14) disposed along the circumference of the inner surface 162 of the track 160. Understandably, the inner surface 162 could also comprise guide lugs or teeth 168, 169 (see FIG. 16) disposed along its circumference. For its part, the outer surface 164 of the track 160 comprises a plurality of traction lugs (see FIG. 15) configured to engage the ground surface over which the track system 100 is operated.

In the present embodiment, the support frame 120 is pivotally mounted to the drive wheel 110 albeit it is not drivingly engaged by the drive wheel 110. In other embodiments, the support frame 120 could be mounted directly to the vehicle.

Still referring to FIGS. 5-10, in the present embodiment, the high performance track system 100 has two main characteristics, a large sprocket size and operation of the vehicle at a low track tension. These two characteristics are preferred to obtain the desired performance from the present embodiment of the high performance track system 100. The term ‘performance’ used throughout refers to a track system performing in a similar manner as wheel performance. As such, one of the factor used in assessing the performance is the speed the vehicle may reach using the present invention. Notably, the efficiency of the track kit system 100 will also impact the speed of the vehicle. Additionally, in the present embodiment, a narrow track band 160 is also typically preferred, but not mandatory.

According to one embodiment of the present invention, the narrower track band 160 is less than 11½ inches wide. As such, this narrower band allows improved handling and driving capabilities of the small vehicle. Although preferred, for the high performance track system, the high performance track system could function with conventional track bands of 11½ inches wide and more.

As it will best be understood below, according to the present embodiment, the large diameter sprocket 110 should be such that a ratio of the sprocket diameter relative to the tire diameter typically ranges from 65 to 100%, preferably 68 to 97%. As such, a 25 teeth sprocket having a 20.1 inches would be used for replacing a 29.5 inches tire/wheel resulting in a sprocket to wheel diameter ratio of 68%. According to another embodiment, a large diameter sprocket of 23.3 inches having 29 teeth could replace a 24 inches tire/wheel for an even greater sprocket to wheel diameter ratio of 97%.

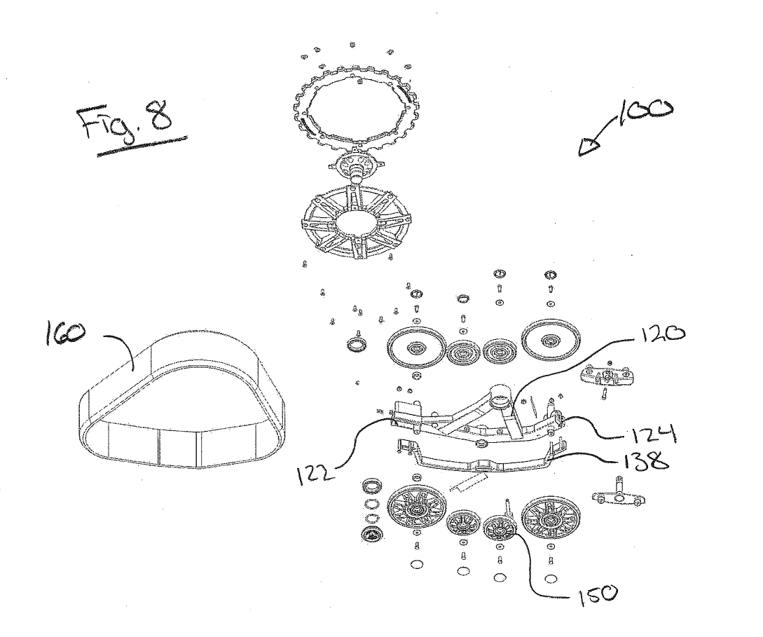

In that sense, now referring to FIG. 8, in the present embodiment, the sprocket has a diameter ratio of 68%, being a 25 teeth of 20.1 inches and configured to replace a 29.5 inches tire/wheel on a small vehicle.

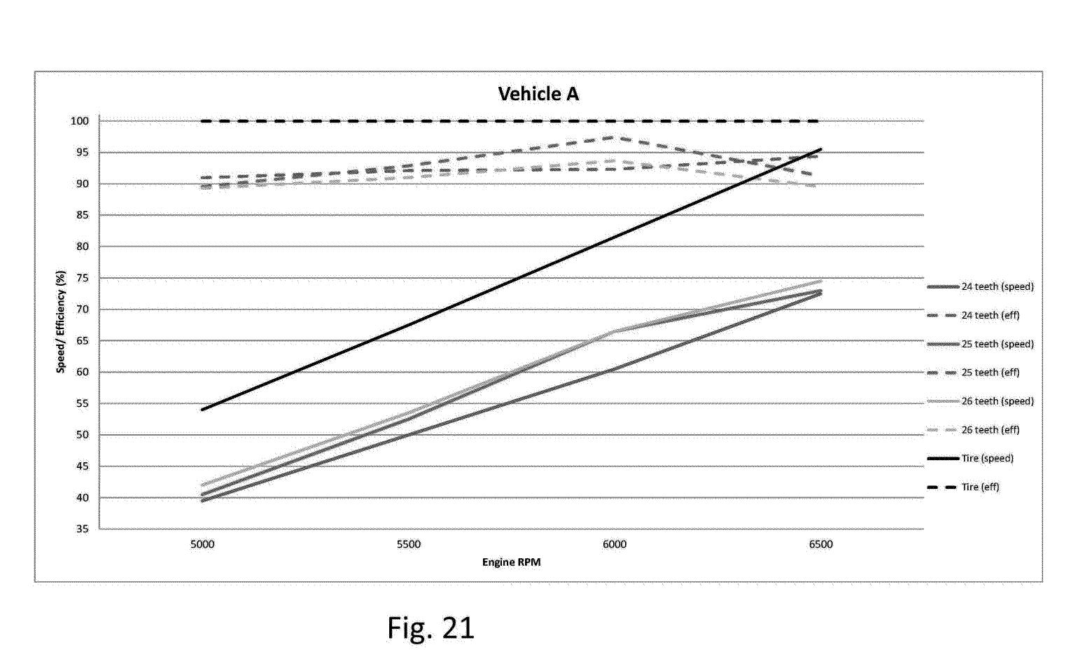

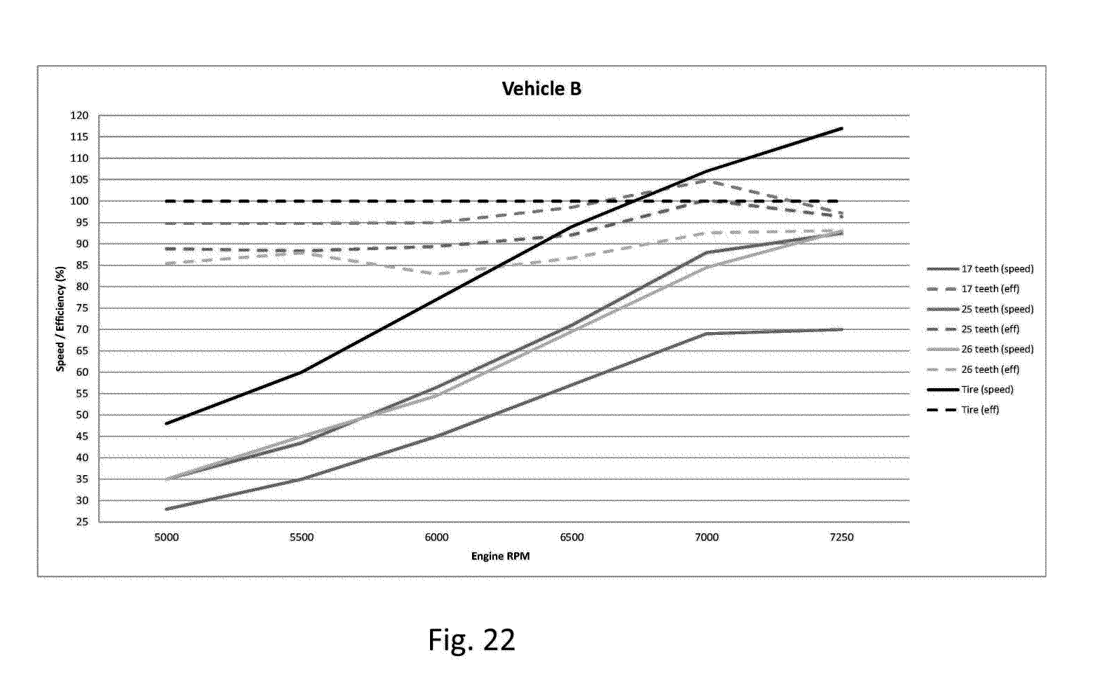

The efficiency of the track system 100 is measured as a percentage obtained from dividing the actual speed value at a specific engine revolution compared with the computed loss of speed as a result of the ratio sprocket 110/wheel 620. For instance, a track system having a 20.1 inches diameter sprocket for replacement of a 25 inches diameter wheel 625 should theoretically achieve about 80% of the speed of the original wheeled vehicle when working under identical engine condition. In other words, a vehicle going 100 km/h at a specific engine revolution on a specific ground type should go at speed of about 80 km/h using the track system at this same engine revolution. In such a case, the track system efficiency would be 100%. However, a loss of speed is generally sustained due to rolling resistance induced by the track system 100 and by the ground softness (See FIGS. 21-22 for exemplary measurement data).

Referring to FIGS. 21-22, efficiency of different sprockets diameters 110 has been measured at a given track tension and on a given ground surface. The 25-teeth sprocket is most efficient at a given RPM range than the 26-teeth sprocket even if the speeds are almost the same. Fuel consumption will be lowered and engine life will be increased if efficiency is respected and closer to 100%.

According to the present embodiment, various features of the high performance track system allow said track system to run at low tensions. By using an external type sprocket 110, which means that the sprocket teeth are passing through the track and contacting on the clips 192, the guidance of the track 160 on the sprocket 110 is increased and the risk of tooth skipping is reduced. On the lower run of the track assembly 100, the guiding slide 138 maintains a continuous contact with the metal clip 192 to ensure a good guidance even at a low tension. Friction is also generally reduced by the sprocket contact on steel instead of sprocket contact on rubber.

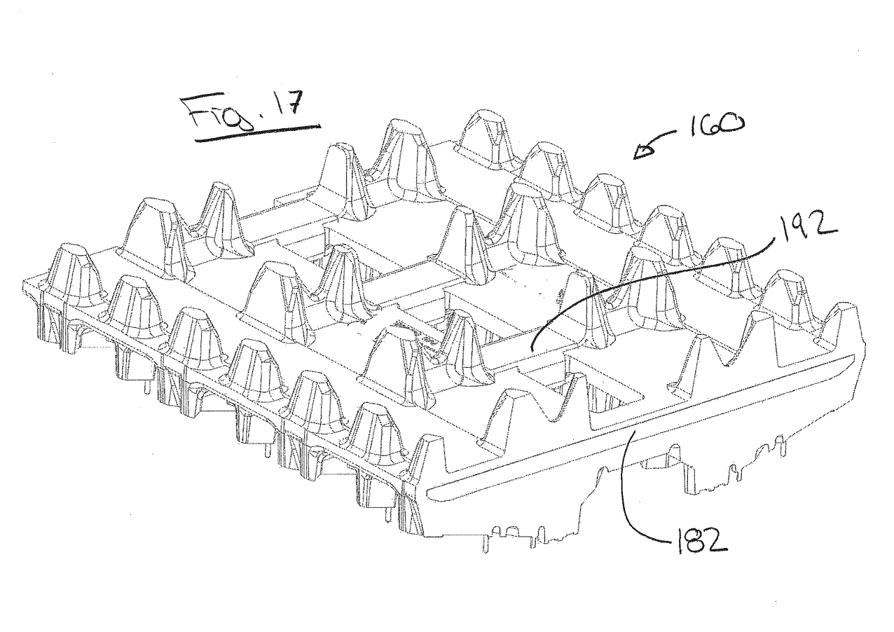

Now referring to FIG. 17, the track band 160 is typically made of elastomeric material such as rubber and typically, but not mandatory, comprises longitudinal reinforcements such as cables, cords, wire ropes and lateral reinforcements such as lateral rods 182, or stiffeners.

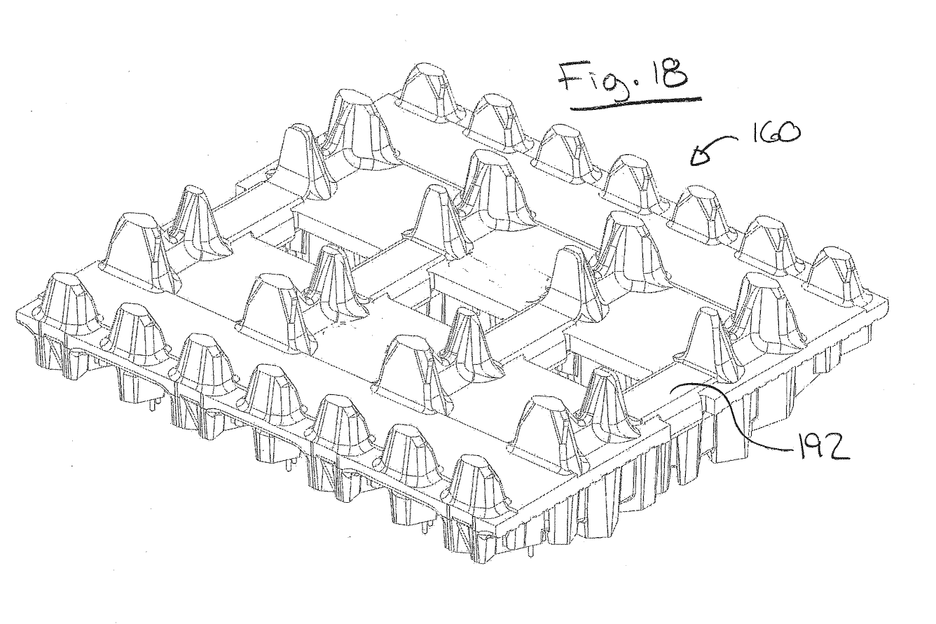

Referring now to FIGS. 14-18, the track band 160 is depicted with double outer guide lug 169, allowing better support of the track band 160 by the wheels. The improved support of the track band 160 from the use of the double outer tooth guide 169, also helps operating the vehicle at very low tension, thus limiting the track band link derailing. Furthermore, the relative position of the teeth 169 about the edge of the track band 160, preferably directly on the edge allows the track band 160 to withstand lateral force such as to prevent the remaining track from attempting to bend the track and push the teeth guides 168, in interference with the wheel ultimately leading to derailment.

Still referring to FIGS. 14-18, according to one embodiment, the track band 160 generally comprises track band clips 192, typically made from hardened material such as metal (i.e. iron) or polymers. The clip allows the use of a lower tension without track link derailing. These track band clips 192 reduce the friction between the track and sprocket tooth 190 thus reducing the resistance generally encountered from the interaction of the driving wheel and track band. These clips improve the functioning of the very low tension track system 100.

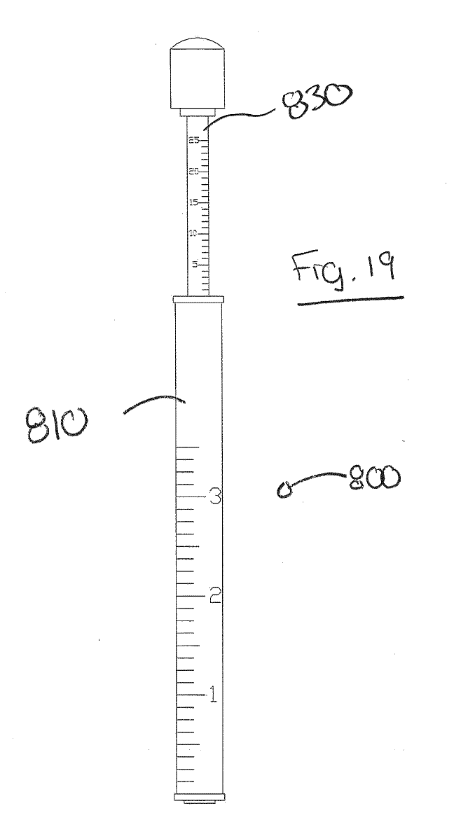

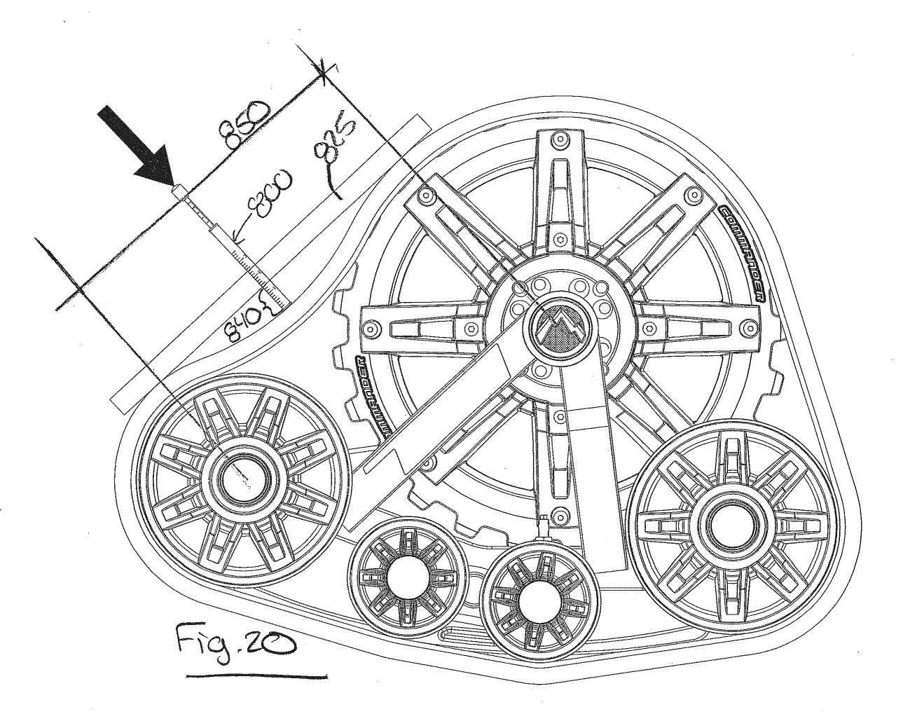

Now referring to FIGS. 19-20, according to the present embodiment, the low resulting operational tension of the high performance track system 100 is generally measured using the resulting tension of a point force at a given location in the track during movement.

In an example of the present invention, the preferred operating tension of the high performance track system is 25 lbs./1½ inches of deflection for an unsupported distance 850 of about 15⅜ inches. An operational tension between 25 lbs./1¼ inches and 25 lbs./1¾ inches will be adequate without significantly affecting the performances of vehicles. Different unsupported distances 850 would result in other deflection tolerances.

Existing track systems, have never driven as recommended adjustments provided in textbooks at lower than 25 lbs./1⅛ inches, the standard is between 25 lbs. tension/½ inches and 25 lbs./¾ inches.

As such, according to an embodiment of the present invention, the low tension track system 100 could be obtained by having a track system 100 wherein the unsupported portion of the track band 160 between the sprocket 110 and idler wheel 130 has a deviation of around 10% of the its length upon centrally applying to the unsupported portion 850 of the track band 160, a 25 lbs weight as shown in FIG. 20. Accordingly, the high performance track system has a low track tension measured by the deviation 840 of the track in its unsupported portion. As such the low tension should yield deviation of the track ranging between 8% and 12%, preferably between 9% and 11% of the length of the unsupported portion 850 upon application of a 25 lbs weight about the center of the unsupported portion.

Now referring to FIGS. 19-20, the tension tester tool 800 is graded in inches on its lower portion 810 and pounds on its exterior portion 830. This tension tester 800 is generally standard for use in measuring belt tension. To measure the track tension, it is necessary to use a ruler or some other straight object. Accordingly, the user typically place the ruler 825 between the sprocket and the idler wheel 130. Then simply place the tool tension 800 roughly centered between the sprocket and the idler wheel 130 and support to achieve the desired strength (i.e. 25 lbs). This force creates a local deflection 840 of the track band 160 (in the tool 800) and the deflection 840 measured at the desired strength gives us the right tension (strength applied, i.e. 25 lbs). In the present embodiment, a force of 25 lbs on the track band 160 should give a total deflection of 1½ inches. The reference measurement (or zero) is the ruler 825 previously placed. Understandably, 25 lbs measurement is used as an example, the person with the skills in the art will understand that tension could be measured using another reference than 25 lbs, in which case the deflection measurement should be proportionally adjusted for such a different tensional measurement.

In the present embodiment, the combination of the large sprocket size and low tension allow reduction of the rolling resistance induced by the interaction between the ground 300 and track system 100. Accordingly, by reducing the global rolling resistance, it is thus possible to improve the overall efficiency of the track system 100 thus allowing the track system 100 to attain higher performances than known systems.

Furthermore, in the present embodiment, another feature that was found to improve the track system efficiency is the track band width. As such, in the track system of FIG. 5 is provided with a narrower track band than known track systems, thus allowing diminished rolling resistance. As such, the narrower the track the lesser the friction from the ground 300 and track band 160 interaction. The narrower track consumes also less energy than a wider track when bending around sprocket 110 and idler wheels 130 and 140 as a result of the hysteresis in the rubber. The narrower track has less rubber to bend.

According to one embodiment, the synergistic combination of a la large sprocket, a very low tension and a narrow track band allow the track system 100 to have an improved performance with a driving behavior that most resemble the driving of the same vehicle using wheels.

According to one embodiment of the present invention, the high performance track system 100 function with an external driving, meaning that the track band 160 is rotated around the track system 100 by the driving wheel 110 respectively applying pressure at the neutral fiber point in the track band preferably on a clip 192 attached thereto. As such, the external driving track system may withstand unusually low track tension without experiencing teeth jumps, also referred as having a ratcheting effect. Consequently, the high performance track system 100 comprise a track band having openings 194 whereby the driving wheel teeth 190 are inserted, thus drivingly engaging the track band 160.

Notably, track tension is a major factor impacting rolling resistance in the track system. As such, having the ability to lower the tension while using an external driving mechanism allows the high performance track system to attain very high efficiency which may reach 90% efficiency at high speeds.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A high performance track system for replacing a tire-wheel assembly of a vehicle, the track system comprising:
a supporting frame;
a sprocket wheel pivotally mounted to the supporting frame and operationally connected to a driving shaft of the vehicle;
a plurality of idler wheels pivotally mounted to the supporting frame for guiding an endless track disposed around the plurality of idler wheels and the sprocket wheel;
the sprocket wheel having a diameter between 65% and 100% of the diameter of the replaced tire-wheel assembly of the vehicle; and the endless track having a tension limiting derailment of the endless track.

2) A track system as claimed in claim 1, wherein the tension in the endless track corresponds to a deflection of more than 1¼ inches but less than 1¾ inches for a pressure of 25 pounds applied at the center of an unsupported distance of 15⅜ inches.

3) A track system as claimed in claim 1, wherein the diameter of the sprocket wheel is between 68% and 97% of the diameter of the tire-wheel assembly of the vehicle.

4) A track system as claimed in claim 1, the endless track having an inner wheel-engaging surface comprising inner guide lugs and outer guide lugs wherein the distance in a longitudinal direction between consecutive inner guide lugs is greater than the longitudinal distance between consecutive outer guide lugs for limiting the derailment of the endless track.

5) A track system as claimed in claim 4, wherein the longitudinal distance between consecutive inner guide lugs is twice the longitudinal distance between consecutive outer guide lugs.

6) A track system as claimed in claim 1, wherein the endless track comprises apertures to be engaged by teeth of the sprocket wheel.

7) A track system as claimed in claim 6, wherein the endless track is reinforced between apertures for limiting a tooth skipping movement between the endless track and the sprocket wheel.

8) An endless track as claimed in claim 1, wherein the endless track comprises inner guide lugs for engaging the sprocket wheel.

9) A track system as claimed in claim 1, wherein the supporting frame further comprises a guiding slide for guiding a lower run of the endless track and for limiting the derailment of the endless track.

10) A track system as claimed in claim 1, wherein width of the endless track is within a range of 75% to 125% of width of the tire-wheel assembly of the vehicle for reducing a rolling resistance.

11) A track system as claimed in claim 1, wherein the endless track comprises widthwise reinforcing rods.

12) A vehicle equipped with a pair of track systems as defined in claim 1.

13) A vehicle equipped with a plurality of pairs of track systems as defined in claim 1.

14) A high performance track system for replacing a tire-wheel assembly of a vehicle, the track system comprising:
a supporting frame comprising a guiding slide for guiding a lower run of an endless track and for limiting a derailment of the endless track;
a sprocket wheel comprising teeth pivotally mounted to the supporting frame and operationally connected to a driving shaft of the wheeled vehicle;
a plurality of idler wheels pivotally mounted to the supporting frame for guiding the endless track disposed around the plurality of idler wheels and the sprocket wheel;
the endless track comprising:
an inner wheel-engaging surface;
an outer ground-engaging surface;
widthwise reinforcing rods; and
apertures to be engaged by the teeth of the sprocket wheel,
wherein the inner wheel-engaging surface comprises inner guide lugs and outer guide lugs; and wherein the sprocket wheel has a diameter between 65% and 100% of the diameter of the tire-wheel assembly of the vehicle; and the endless track having a tension limiting derailment of the endless track.

15) A track system as claimed in claim 14, wherein the tension in the endless track corresponds to a deflection of more than 1¼ inches but less than 1¾ inches for a pressure of 25 pounds applied at the center of an unsupported distance of 15⅜ inches.

16) A track system as claimed in claim 14, wherein the diameter of the sprocket wheel is between 68% and 97% of the diameter of the tire-wheel assembly of the vehicle.

17) A vehicle equipped with a pair of track system as defined in claim 14.

18) A vehicle equipped with a plurality of pairs of track systems as defined in claim 14.
